(19) United States
(12) Patent Application Publication
(10) Pub. No.: US 2012/0324569 A1
(43) Pub. Date: Dec. 20, 2012

(54) RULE COMPILATION IN A FIREWALL

(75) Inventors: David Diehl, Minneapolis, MN (US); Steven O. Chew, Pittsburgh, PA (US)

(73) Assignee: McAfee, Inc., Santa Clara, CA (US)

(21) Appl. No.: 13/161,477

(22) Filed: Jun. 15, 2011

(51) Int. Cl. G06F 21/00

(52) U.S. Cl. 726/14

(57) ABSTRACT

A firewall system comprises a rule compiler operable to use florets and factoring to produce a rule data structure that enables a rules engine to apply a rule from a rule set in phases, including rules applicable during a first scan with second factors not available and rules applicable during a second scan such that only the second factors need be applied.

### FIELD OF THE INVENTION

The invention relates generally to managing rule sets, and more specifically in one embodiment to compiling rules in a firewall.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users or pranksters to attempt to communicate with other users' computers in a manner that poses a danger to the other users. For example, a hacker may attempt to log in to a corporate computer to steal, delete, or change information. Computer viruses or Trojan horse programs may be distributed to other computers, or unknowingly downloaded or executed by large numbers of computer users. Further, computer users within an organization such as a corporation may on occasion attempt to perform unauthorized network communications, such as running file sharing programs or transmitting corporate secrets from within the corporation's network to the Internet.

For these and other reasons, many corporations, institutions, and even home users use a network firewall or similar device between their local network and the Internet. The firewall is typically a computerized network device that inspects network traffic that passes through it, permitting passage of desired network traffic based on a set of rules.

Firewalls perform their filtering functions by observing communication packets, such as TCP/IP or other network protocol packets, and examining characteristics such as the source and destination network addresses, what ports are being used, and the state or history of the connection. Some firewalls also examine packets traveling to or from a particular application, or act as a proxy device by processing and forwarding selected network requests between a protected user and external networked computers.

The firewall typically controls the flow of network information by monitoring connections between various ports, sockets, and protocols, such as by examining the network traffic in a firewall. Rules based on socket and other information are used to selectively filter or pass data, and to log network activity. Firewall rules are typically configured to identify certain types of network traffic that are to be prohibited or that should have certain other restrictions applied, such as blocking traffic on ports known to be used for file sharing programs while virus scanning any data received over a traditional FTP port.

But, the number of rules needed to configure a firewall to handle the large variety of network traffic that is often present in even a small office can be daunting to manage. Hundreds or even thousands of rules are sometimes applied, with additional complexity in that rules are often processed in order such that the order in which rules are listed can affect the rules applied.

### SUMMARY

Various example embodiments of the invention comprise a firewall system operable to use florets and factoring to produce a rule data structure that enables a rules engine to apply a rule from a rule set in phases, including rules applicable during a first scan with second factors not available and rules applicable during a second scan such that only the second factors need be applied. The rules are factored and florets are generated using a rule compiler in a further example.

### BRIEF DESCRIPTION OF THE FIGURES

FIG. 1 shows an example network including a firewall, as may be used to practice some embodiments of the invention.

FIG. 2 is a simplified rule set, consistent with an example embodiment of the invention.

FIG. 3 illustrates compilation of a simplified rule set using florets and factoring, consistent with an example embodiment of the invention.

FIG. 4 illustrates compilation of a more complex rule set using florets, consistent with an example embodiment of the invention.

FIG. 5 illustrates compilation of a more complex rule set using factoring, consistent with an example embodiment of the invention.

FIG. 6 is a compiled rule set including florets derived from the factored rule set of FIG. 5, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

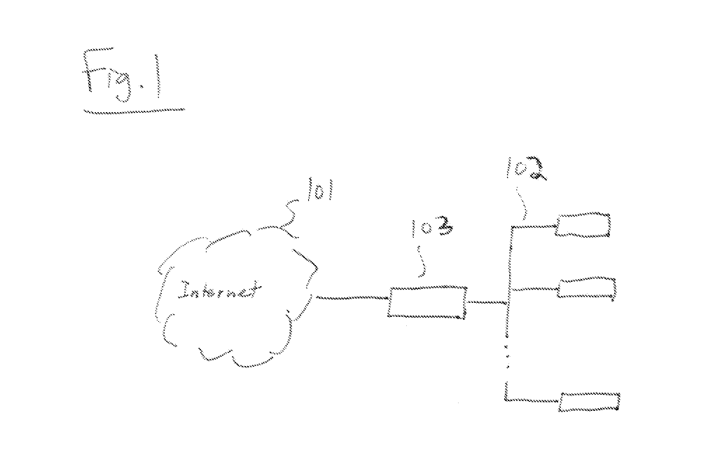

FIG. 1 illustrates a typical computer network environment, including a public network such as the Internet at 101, a private network 102, and a computer network device operable to provide firewall and intrusion protection functions shown at 103. In this particular example, the computer network device 103 is positioned between the Internet and the private network, and regulates the flow of traffic between the private network and the public network.

The network device 103 is in various embodiments a firewall device, and intrusion protection device, or functions as both. A firewall device or module within the network device provides various network flow control functions, such as inspecting network packets and dropping or rejecting network packets that meet a set of firewall filtering rules. As described previously, firewalls typically perform their filtering functions by observing communication packets, such as TCP/IP or other network protocol packets, and examining characteristics such as the source and destination network addresses, what ports are being used, and the state or history of the connection. Some firewalls also examine packets traveling to or from a particular application, or act as a proxy device by processing and forwarding selected network requests between a protected user and external networked computers. Firewalls often use “signatures” or other characteristics of undesired traffic to detect and block traffic that is deemed harmful or that is otherwise undesired.

Firewalls typically use sets of rules to filter traffic, such that what happens with any particular element of network data is dependent on how the rule set applies to that particular data. For example a rule blocking all traffic to port 6346 will block incoming traffic bound for that port on a server within the protected network, but will not block other data going to the same server on a different port number. The order of rules also plays a role in operation, such that if a prior rule says to allow all traffic from a particular range of IP addresses irrespective of the destination IP address or port, the incoming connection request to port 6346 will be allowed based on the IP address rule being processed before the port 6346 rule.

As has been previously discussed, the order of two or more separate rules can influence which rule is applied to certain network traffic, such that the operation of apparently conflicting or overlapping rules depends on rule ordering in the rule set. The firewall administrator responsible for configuring the firewall and managing the rule set typically uses a tool that presents rules in a readable and ordered interface, and balances trust, firewall performance, and rule set size and manageability in determining how to configure firewall rules to best suit a particular network environment.

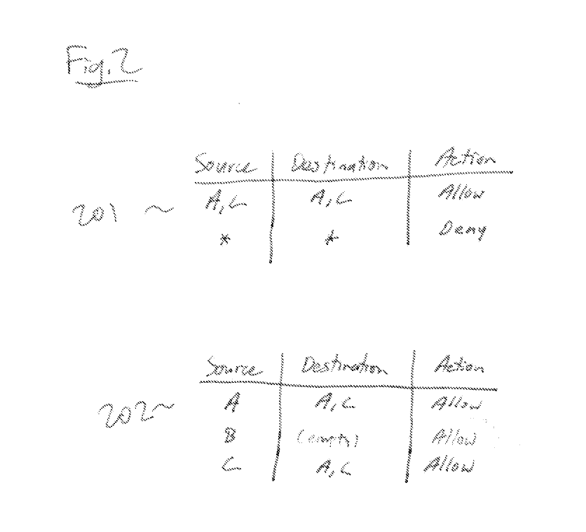

But, the rule set provided to the administrator may not be the most efficient representation of the rules for a firewall to use in applying the rules to network traffic. One such simplified example rule set is presented in FIG. 2, consistent with an example embodiment of the invention. Here, a rule set as presented to an administrator allows specification of multiple source and destination elements, such as to allow all traffic from A or C to A or C, while denying all other traffic using only two rules as shown at 201.

From a firewall's perspective, a rule engine may be configured to do a fast rule lookup based on the source, and consequently use a rule language that allows grouping in the destination but not the source. The rule set of 201 is converted or compiled to a rule set meeting the rule engine's requirements, as shown at 202. Here, wildcards and grouping are only allowed in the destination field, and only a single rule per source is allowed. The compiled rules at 202 are also all specified in terms of allowable actions, and the firewall operates with a default “deny” action such that any relationship not explicitly allowed will be denied.

The result is that for network traffic from either of sources A or C, anything with a destination of A or C will be allowed, just as in the rule set of 201. Network traffic coming from source B will never be allowed, as the “destination” field is blank for source B in the table at 202, and therefore no destination source is specified as being allowed to receive traffic from source B.

The policy expression shown by the rules at 202 is the same as the policy expressed by the rules at 201, and is the only correct way to specify the rule set given the rule set or “language” constraints used to form the rule set at 202 as the information in both the source and action columns is fixed (one and only one rule per source, action is always “allow”). If more than one column of data is free, multiple expressions of the rule policy are possible, and ensuring that rule compilation results in an equivalent compiled rule set can become a more complex problem.

The problem of compiling a rule set is further complicated if the engine is complex, such as configured to perform multiple scans on data at different points in the data stream. In a more detailed example, a firewall performs an initial scan based on known information such as source and destination IP, and port number of the source and destination computer systems. A subsequent scan is performed once more information is available, such the applications initiating or involved with a given network connection. The rules could be simply applied during the first scan to determine whether there is a possible allowing outcome of the second scan such that only those connections that are not potentially allowable are denied, this results in some data leakage through the firewall for potentially undesirable connections and requires that full scans be run twice.

Multiple scans can be made more efficient by running only those rules determined in the first scan to be potentially applicable during the second scan, greatly reducing the size of the second scan's applied rule set. Further, the second scan can scan only those dimensions of the rule set not available during the first scan, reducing the computational burden of applying the potentially applicable rules.

But, determination and tracking of the rules that are potentially applicable during a second scan takes significant computational resources, as does determining and tracking which dimensions of the potentially applicable rule set were not available during the first scan. Some embodiments of the invention therefore compile a firewall rule set into rules applicable during a first scan with limited data available and rules applicable during a second scan, such that these determinations do not have to be made at run-time or during active filtering.

Compilation of a rule set into first and second phase scan rules in a more detailed embodiment comprises use of rule transformations known as florets and factoring. Florets are secondary or compiled rules constructed such that only a single floret associated with the first matching first phase rule need be evaluated in the second phase, reducing the computational burden on the firewall rules engine to only those determinations that might affect the outcome. Constructing a floret during rule compilation therefore involves taking rules which are have at least some overlapping selectors in the first phase of the evaluation and gathering their second phase elements into a second phase policy known as a floret. The outcome of the floret in a further example includes not only the outcome of the original user rule, but an indication of which original or precompilation rule resulted in the outcome.

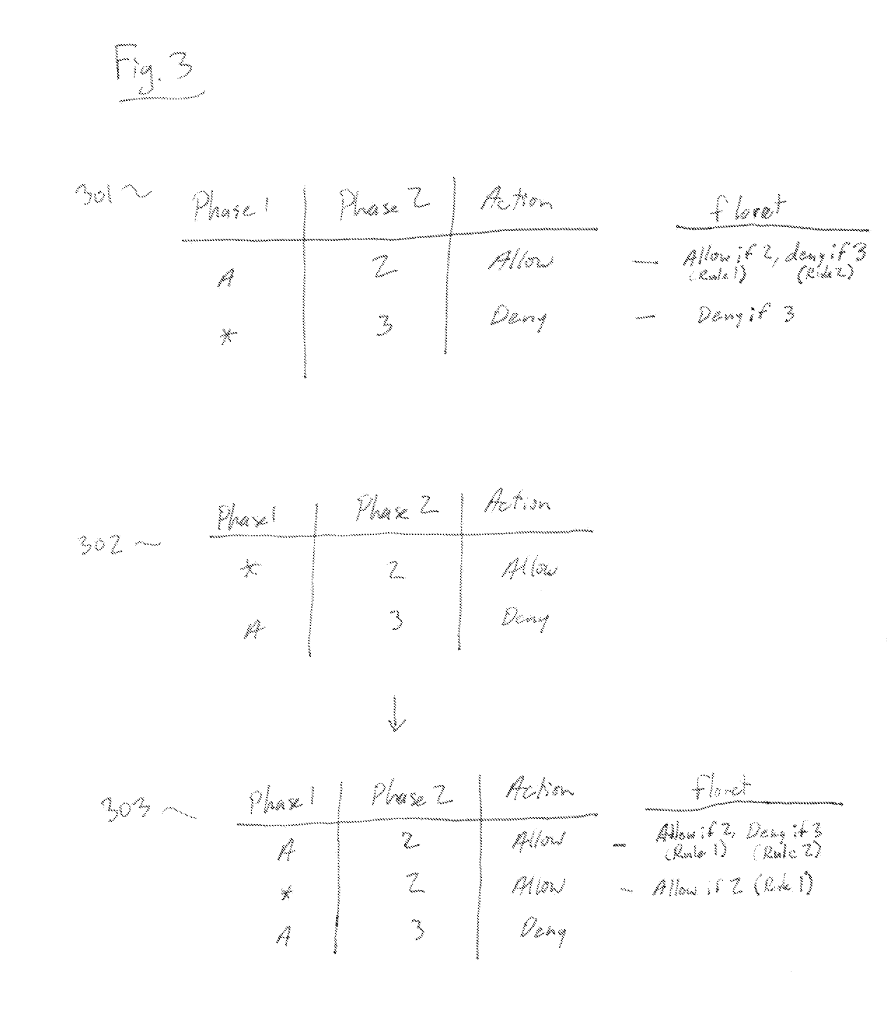

FIG. 3 illustrates construction and use of a floret, consistent with an example embodiment of the invention. Here, we examine two rules that may be applicable when the first phase source is an “A”, as a part of constructing a floret for the first rule. At 301, the first phase elements of two rules are ordered to allow traffic from source “A” conditional on second phase finding of application “2”, and to traffic from all sources conditional on the second phase finding of application “3”. Because the first rule's first phase source A is a subset of the second rule's first phase source “*” (wildcard, or all), the first rule applies to a subset of the second rule in phase one. When a first rule's first phase elements are a subset (including equivalence) of a second rule, knowing that the first rule applies to every case the second rule applies enables us to simply build a second phase floret for the first rule that includes both the first and second rule's second phase elements or selectors, which in this case includes allowing protocol 2 and denying protocol 3.

Similarly, if the first rule's second phase elements are a superset of the second rule's second phase elements, any connection which matches the first rule would never reach the second rule in the second phase, so it is sufficient to build a floret for the first rule without reference to the second rule's second phase elements. Because that is not the case here, the second rule's second phase elements are referenced in the floret at 301.

If the first rule is not a subset (including equivalence) of the second rule, forming florets or rules for second phase can become more complex. Consider the two rules shown at 302, in which the first phase applicability of the first rule is not a subset or equivalent of the second rule, but is instead a superset of the second rule. In this example, forming a floret for the first rule that allows a network connection if the second phase application is 2 and denies the network connection if the second phase application is three may result in an incorrect outcome, as the rule applies to all sources and not just to source A. That is, some but not all connections that match the first rule will need the second rule's information applied.

As previously discussed, the floret in this example is constructed such that only information not available in the first phase is evaluated, improving the run-time performance of the firewall system. Although a floret for the first rule could be constructed in a way that was conditional upon both the phase 2 information and phase 1 information, it is more efficient to perform a factoring process on the two rules in which a third rule is produced, to produce florets in which only second phase information is evaluated.

In the example rule set shown at 302, we have already determined that rule 1 is not a subset or equivalent of rule 2 based on first phase selectors, but that the two rules intersect. Further, we can determine whether the second phase result of the first rule is a superset of the second rule, such that the second rule will never be applied. As that is not the case here, the rule compiler will create a new “factor” rule that is the first phase intersection of the two rules, and place the factor rule before the first of the two existing rules.

More concisely, a factor rule is created when the first rule is not a subset of the second rule in first phase evaluation but the first phases intersect, and the first rule is not a superset of the second rule in second phase evaluation. The resulting factor rule comprises an intersection of the first phase selectors, and second phase selectors and outcome are copied from the first of the two rules. This is shown at 303, where a new rule A is created that allows the application types as identified in the previous rule 1 for source A, the first phase intersection of the two previous rules. The new rule ensures that network connections from source A are evaluated by a floret associated with the new factor rule rather than by a floret associated with the wildcard or broader rule that was previously the first rule, enabling construction of complete florets associated with the rules that only involve evaluation of second phase data.

Florets are constructed for the rules as before, resulting in the florets as shown at 303. Because the first phase criteria for rules one and three are identical, rule three will never be reached in the modified rule set and a floret need not be created. The second phase and action information from rule 3 are included in the factor rule that is now rule 1. Although the florets in this example also retain an indication of which rule results in the outcome of application of the floret, they refer to the precompiled rules as shown at 302 such that the rule applied may be more easily referenced by an administrator.

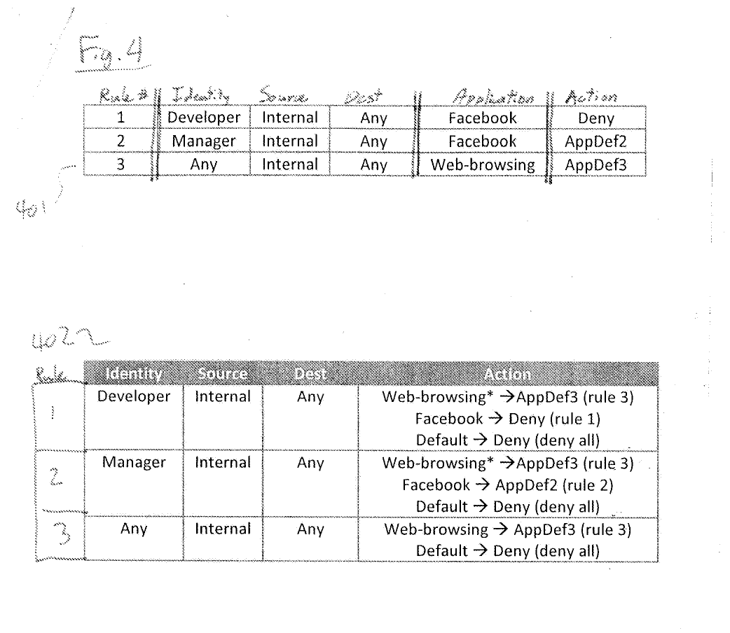

A more complex application of florets is shown in FIG. 4, consistent with an example embodiment of the invention. Here, a rule set of three rules is shown at 401, including first phase information such as identity, source, and destination, second phase information indicating the application associated with the network connection, and an action for each of the rules. We wish to compile the rule set shown at 401 to produce florets, enabling more efficient second phase processing of the rules.

Looking at the first phase selectors, rule one is a subset of rule three and rule two is a subset of rule three, but the relationship between rules two and three is less clear as different people may be managers but not developers, developers but not managers, both managers and developers, or neither managers nor developers.

Because the only potential intersection between rules where the first rule is not a subset of the second rule in first phase evaluation occurs in rules 1 and 2, we can exclude the other rule pairs from consideration for factoring. We then further consider whether the first of rules 1 and 2 is a superset (including equality) of the second rule in second phase evaluation. As this is the case here, we do not need to factor rules 1 and 2 before creating florets.

We can therefore create florets for each of the rules by gathering second phase elements of subsequent applicable rules into each rule's floret, as indicated at 402. In this example, the default action if a rule does not explicitly allow a connection is to deny the connection, resulting in each floret ending with a default “deny” action for network connections not otherwise addressed. Rule numbers of original rules as shown at 401 are again associated with each floret element, so that the original rule responsible for the action taken can be identified. As the second phase selector of rule 1 was equal or a superset of the second phase selector of rule 2, the floret of rule 1 need not include the Facebook action of rule 2, as rule 2 will never be reached by those who are developers.

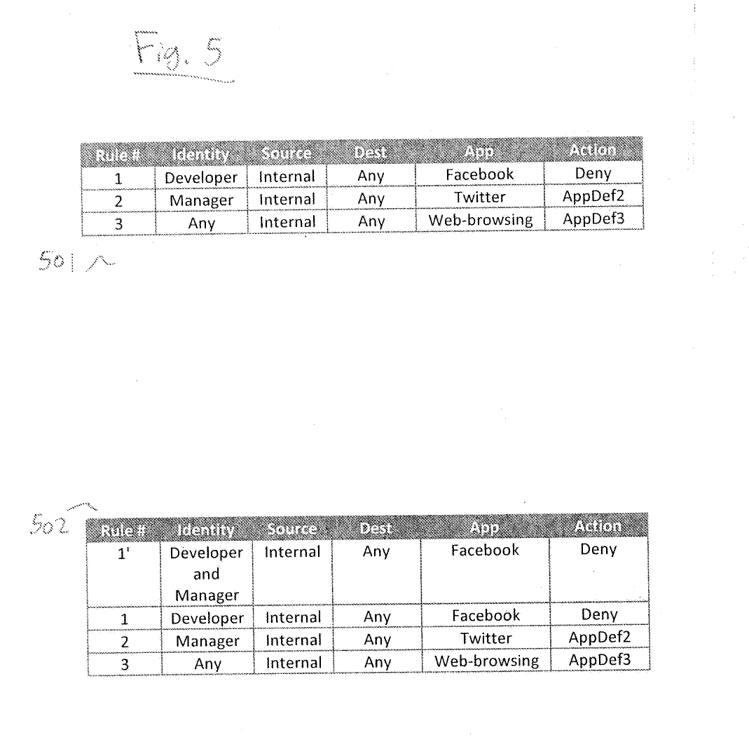

FIG. 5 shows a more complex rule set requiring factoring to compile the rule set and produce florets, consistent with an example embodiment of the invention. Here, the rules are substantially similar to the rules of FIG. 4, except that the application identified by rules 1 and 2 are not the same, as shown at 501. More significantly, it is no longer the case that the first of rules 1 and 2 is a superset (including equality) of the second rule in second phase evaluation, so rules 1 and 2 require factoring before florets can be accurately produced.

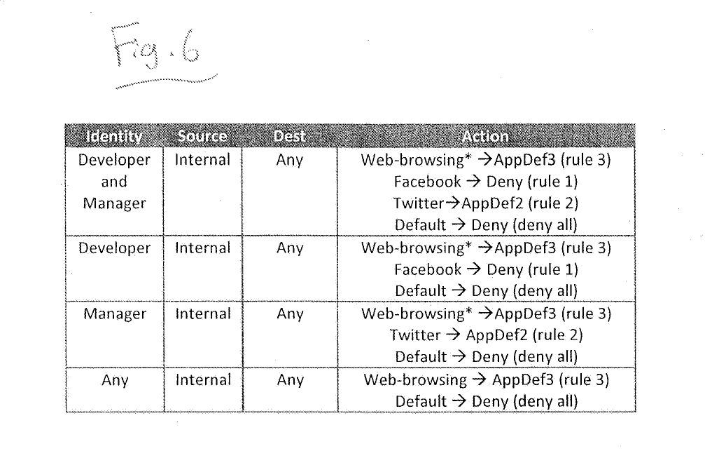

Factoring is performed as before, by inserting a new rule before the first of these two rules where the first phase criteria intersections are used as the first phase selectors for the new rule, and the second phase selectors and action are taken from the first of the two rules. This is shown as rule 1′ at 502, where the intersection of the original rule 1 applied to developers and rule 2 applied to managers is shown to be people who are both developers and managers. Once the factored rule is inserted as shown at 502, florets can be determined for each rule as shown in FIG. 6.

Referring to FIG. 6, the floret for the new factor rule ensures that someone who is both a developer and a manager will be denied Facebook access under rule 1 but still be able to use twitter under rule 2, without applying this same set of conditions to people who are developers but not managers. This factoring example does require that the rules engine be able to apply an AND relationship between first phase selectors, in this case to identify those network connections belonging to users who are both developers and managers.

The methods illustrated here use simplified rule sets and two phases of evaluation, but applications using large and complex rule sets with many more selectors, and more than two phases of evaluation are also possible using these methods and are within the scope of the invention. The examples here also deal with a single firewall doing multiple phases of evaluation, while other examples will include handling later phases in a proxy or other module, such that the different phases of rule application need not be handled by the same rules engine.

These examples illustrate how a firewall rule set can be compiled using methods such as florets and factoring to produce a rule data structure that enables a rules engine to apply a rule set in phases, including rules applicable during a first scan with limited data available and rules applicable during a second scan, such that these determinations do not have to be made at run-time or during active filtering. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A firewall system comprising a rule compiler operable to:
generate a floret for a first rule, the floret derived from first phase and second phase selectors of the first rule and a subsequent rule;
wherein evaluation of the first phase selectors of the first rule against a network connection in a first phase and evaluation of the rule's generated floret against the network connection in a second phase results in logical application of first and subsequent rules against the network connection.

2. The firewall system of claim 1, the rule compiler further operable to factor the first and subsequent rules by adding a factor rule before the first rule, the factor rule comprising a first phase selector that is the intersection of the first phase selectors of first and subsequent rules, and a second phase selector and an action from the first rule.

3. The firewall system of claim 2, wherein the factoring rules occurs before generating florets for rules.

4. The firewall system of claim 2, wherein rules are identified to be factored by determining that the first rule is not a subset of the subsequent rule based on the first phase selectors, and determining that the first rule is not a superset of the subsequent rule based on the second phase selectors.

5. The firewall system of claim 1, wherein generating a floret for at least one rule further comprises identifying at least one subsequent rule such that the at least one rule's first phase selectors are a subset of the subsequent rule's first phase selectors, and assembling at least second phase and action selectors of the identified at least one subsequent rule into the floret.

6. The firewall system of claim 1, wherein the floret selectors comprise only second or subsequent phase selectors.

7. A method of operating a firewall system, comprising:
generating a floret for a first rule, the floret derived from first phase and second phase selectors of the first rule and a subsequent rule;
wherein evaluation of the first phase selectors of the first rule against a network connection in a first phase and evaluation of the rule's generated floret against the network connection in a second phase results in logical application of first and subsequent rules against the network connection

8. The method of operating a firewall system of claim 7, the rule compiler further operable to factor the first and subsequent rules by adding a factor rule before the first rule, the factor rule comprising a first phase selector that is the intersection of the first phase selectors of first and subsequent rules, and a second phase selector and an action from the first rule.

9. The method of operating a firewall system of claim 8, wherein the factoring rules occurs before generating florets for rules.

10. The method of operating a firewall system of claim 8, wherein rules are identified to be factored by determining that the first rule is not a subset of the subsequent rule based on the first phase selectors, and determining that the first rule is not a superset of the subsequent rule based on the second phase selectors.

11. The method of operating a firewall system of claim 7, wherein generating a floret for at least one rule further comprises identifying at least one subsequent rule such that the at least one rule's first phase selectors are a subset of the subsequent rule's first phase selectors, and assembling at least second phase and action selectors of the identified at least one subsequent rule into the floret.

12. The method of operating a firewall system of claim 7, wherein the floret selectors comprise only second or subsequent phase selectors.

13. A tangible machine-readable medium with instructions stored thereon, the instructions when executed operable to cause a computerized system to:
generate a floret for a first rule, the floret derived from first phase and second phase selectors of the first rule and a subsequent rule; and
evaluate the first phase selectors of the first rule against a network connection in a first phase and evaluation of the rule's generated floret against the network connection in a second phase, resulting in logical application of first and subsequent rules against the network connection

14. The tangible machine-readable medium of claim 13, the rule compiler further operable to factor the first and subsequent rules by adding a factor rule before the first rule, the factor rule comprising a first phase selector that is the intersection of the first phase selectors of first and subsequent rules, and a second phase selector and an action from the first rule.

15. The tangible machine-readable medium of claim 14, wherein the factoring rules occurs before generating florets for rules.

16. The tangible machine-readable medium of claim 14, wherein rules are identified to be factored by determining that the first rule is not a subset of the subsequent rule based on the first phase selectors, and determining that the first rule is not a superset of the subsequent rule based on the second phase selectors.

17. The tangible machine-readable medium of claim 13, wherein generating a floret for at least one rule further comprises identifying at least one subsequent rule such that the at least one rule's first phase selectors are a subset of the subsequent rule's first phase selectors, and assembling at least second phase and action selectors of the identified at least one subsequent rule into the floret.

18. The tangible machine-readable medium of claim 13, wherein the floret selectors comprise only second or subsequent phase selectors.

19. A firewall system comprising a rule engine operable to apply a first rule from a rule set in a first phase and a second phase, the first rule including both a first phase selector applied in a first phase and a second phase selector applied in a second phase with a second phase selector from a subsequent rule, the second phase selector applied in the second phase such that the first phase selectors need not be reconsidered in application of the second phase selector.

20. The firewall system of claim 19, the rule engine further operable to apply the rule via application of florets and factoring rules to apply the second phase selector from the first rule and a subsequent rule.

21. A method of operating a firewall system, comprising:
applying a first rule from a rule set in a first phase and a second phase, the first rule including both a first phase selector applied in a first phase and a second phase selector applied in a second phase with a second phase selector from a subsequent rule, the second phase selector applied in the second phase such that the first phase selectors need not be reconsidered in application of the second phase selector.

22. The method of operating a firewall system of claim 21, further comprising applying the rule via application of florets and factoring rules to apply the second phase selector from the first rule and a subsequent rule.
